(19) United States
(12) Patent Application Publication
(10) Pub. No.: US 2024/0274990 A1
(43) Pub. Date: Aug. 15, 2024

(54) CYLINDRICAL BATTERY CELL, BATTERY AND METHOD FOR FORMING CYLINDRICAL BATTERY CELL

(71) Applicant: HEFEI GOTION HIGH-TECH POWER ENERGY CO., LTD., Hefei, Anhui (CN)

(72) Inventors: Azad DARBANDI, Gottingen (DE); Tobias SCHMIEG, Gottingen (DE); Qian CHENG, Hefei, Anhui (CN); Chen LI, Hefei, Anhui (CN)

(21) Appl. No.: 18/563,355

(22) PCT Filed: Jul. 12, 2021
(86) PCT No.: PCT/CN2021/105754

§ 371 Date: Nov. 21, 2023

(51) Int. Cl. H01M 50/528; H01M 50/107; H01M 50/152; H01M 50/559; H01M 50/627

(52) U.S. Cl. CPC H01M 50/528; H01M 50/152; H01M 50/559; H01M 50/107; H01M 50/627

(57) ABSTRACT

A cylindrical battery cell, a battery and a method for forming cylindrical battery cell are provided. In the cylindrical battery cell, a cap component at least includes a terminal, a fixing element and a cap plate, the terminal including a step-shape structure, wherein the step-shape structure includes a substrate portion and a rivet portion, the substrate portion being blocked on a first side of the cap plate, the rivet portion being extended from the substrate portion, the fixing element being connected to an outer side of the rivet portion on a second side of the cap plate. Therefore, an energy gravimetric and volumetric density of the battery cell are increased, and a cell inner resistance and an energy loss are decreased. Furthermore, a manufacturing process is simplified and costs consequently are reduced.

### CROSS-REFERENCE TO RELATED APPLICATION

The present disclosure is a national stage application of International Patent Application No. PCT/CN2021/105754, which is filed on Jul. 12, 2021, the disclosure of which is hereby incorporated by reference in its entirety.

### TECHNICAL FIELD

Embodiments of the present disclosure generally relate to the field of battery, and more particularly, to a cylindrical battery cell, a battery and a method for forming cylindrical battery cell.

### BACKGROUND

A battery (such as an automotive battery) in general includes a plurality of battery cell. As a kind of battery cell, a cylindrical battery cell is used recently. For example, form factors of the cylindrical battery cell may be from 2170 (diameter is 21 mm and height is 70 mm) to 50120 (diameter is 50 mm and height is 120 mm), and the cylindrical battery cell may at least include a cell housing and a jellyroll structure.

In general, the cylindrical battery cell needs to have a special current path within a cell design in order to ensure enough ampacity. Hence a resistive spot welding of an anode current collector to a steel cell housing is not applicable for larger cell sizes (e.g. 4680 or larger). In some schemes, it is suggested to join a current collector and a steel cell housing by long welding seam created by a laser beam or an ultrasonic.

This section introduces aspects that may facilitate a better understanding of the disclosure. Accordingly, the statements of this section are to be read in this light and are not to be understood as admissions about what is in the prior art or what is not in the prior art.

### SUMMARY

However, the inventors found that: a terminal is fixed in a cap plate by using a pin structure in a center of the terminal in existing schemes, this terminal structure limits a volumetric filling ratio and consequently a volumetric energy density of the battery cell. Furthermore, a current collector has to be pre-welding to the terminal in advance, this terminal structure leads a longer current path (from tabs to the terminal) and/or less available welding area, this increases a cell inner resistance and causes a higher energy loss (low energy efficiency).

In order to solve at least part of the above problems, methods and devices are provided in the present disclosure. Features and advantages of embodiments of the present disclosure will also be understood from the following description of specific embodiments when read in conjunction with the accompanying drawings, which illustrate, by way of example, the principles of embodiments of the present disclosure.

In general, embodiments of the present disclosure provide a cylindrical battery cell, a battery and a method for forming cylindrical battery cell. It is expected to increase an energy gravimetric and volumetric density of the battery cell, and decrease a cell inner resistance and an energy loss.

In a first aspect, a cylindrical battery cell is provided. The cylindrical battery cell at least includes: a cell housing having a cylindrical lateral portion; a jellyroll structure which is arranged inside the cell housing; and a cap component which is arranged on the jellyroll structure and is connected to the cylindrical lateral portion on a first side of the cell housing;
wherein the cap component at least comprises a terminal, a fixing element and a cap plate, the cap plate having an opening, the terminal comprising a step-shape structure and being arranged in the opening via the step-shape structure,
wherein the step-shape structure comprises a substrate portion and a rivet portion, the substrate portion being blocked on a first side of the cap plate, the rivet portion being extended from the substrate portion and through the opening, the fixing element being connected to an outer side of the rivet portion on a second side of the cap plate.

In some embodiments, an injection hole is arranged in the terminal, and the rivet portion is around the injection hole in a circumference direction to form a decentralized structure.

In some embodiments, a space is formed by the rivet portion on a second side of the terminal; and a first groove portion is arranged on a second side of the terminal within the space and around the injection hole in the circumference direction.

In some embodiments, a space is formed by the rivet portion on a second side of the terminal; and a second groove portion is arranged on a second side of the terminal within the space and connected to the injection hole.

In some embodiments, a space is formed by the rivet portion on a second side of the terminal; and a third groove portion is arranged on a first side of the terminal and around the injection hole in the circumference direction.

In some embodiments, a fourth groove portion is arranged on a first side of the terminal and around the injection hole in the circumference direction.

In some embodiments, one or more flattened tabs of the jellyroll structure on a first side of the jellyroll structure is/are welded with a current collector, the current collector being connected to the terminal.

In some embodiments, the current collector comprises a flat plate and a raised portion, the raised portion being extended from the flat plate and having an opening.

In some embodiments, the raised portion comprises at least one bended portion to form a tolerance structure.

In some embodiments, the raised portion is arranged within a space formed by the rivet portion on a second side of the terminal when the terminal and the jellyroll structure are assembled.

In some embodiments, an ending part of the raised portion is inserted into a first groove portion which is arranged on the second side of the terminal.

In some embodiments, the terminal and the current collector are weld by a laser at a first position corresponding to the ending part of the raised portion from outside of the cell housing.

In some embodiments, an ending part of the raised portion is arranged in a second groove portion between an injection hole and the rivet portion in a radial direction.

In some embodiments, the terminal and the current collector are weld by a laser at a second position corresponding to the ending part of the raised portion from outside of the cell housing.

In some embodiments, an ending part of the raised portion is arranged at a third position on a second side of the terminal, the third position being corresponding to a third groove portion arranged on a first side of the terminal.

In some embodiments, the terminal and the current collector are weld by a laser at the third groove portion from outside of the cell housing.

In some embodiments, the current collector comprises a flat plate, the flat plate having an opening.

In some embodiments, an ending part of the plat plate is arranged at a fourth position on a second side of the terminal, the fourth position being corresponding to a fourth groove portion arranged on a first side of the terminal.

In some embodiments, the terminal and the current collector are weld by a laser at the fourth groove portion from outside of the cell housing.

In some embodiments, the cap component further comprises:
a first holding element which is arranged on the first side of the cap plate and is used to isolate the terminal and the cap plate; and
a second holding element which is arranged on the second side of the cap plate and is used to isolate the terminal and the cap plate.

In some embodiments, the cap component further comprises: a sealing element which is arranged between the cap plate and the terminal.

In some embodiments, the cap plate is supported by a crimped neck of the cell housing.

In some embodiments, the cap plate and the cell housing are integrally formed.

In a second aspect, a method for forming cylindrical battery cell is provided. The method includes: forming a jellyroll structure; forming a cap component and a cell housing having a cylindrical lateral portion; and inserting the jellyroll structure into the cell housing;
wherein the cap component at least comprises a terminal, a fixing element and a cap plate, the cap plate having an opening, the terminal comprising a step-shape structure and being arranged in the opening via the step-shape structure,
wherein the step-shape structure comprises a substrate portion and a rivet portion, the substrate portion being blocked on a first side of the cap plate, the rivet portion being extended from the substrate portion and through the opening, the fixing element being connected to an outer side of the rivet portion on a second side of the cap plate.

In a third aspect, a battery is provided, the battery includes a plurality of the cylindrical battery cells according to the first aspect of the embodiments.

According to various embodiments of the present disclosure, a cap component at least includes a terminal, a fixing element and a cap plate, the terminal including a step-shape structure, wherein the step-shape structure includes a substrate portion and a rivet portion, the substrate portion being blocked on a first side of the cap plate, the rivet portion being extended from the substrate portion, the fixing element being connected to an outer side of the rivet portion on a second side of the cap plate.

Therefore, an energy gravimetric and volumetric density of the battery cell is increased, and a cell inner resistance and an energy loss are decreased. Furthermore, a manufacturing process is simplified and costs consequently are reduced.

### BRIEF DESCRIPTION OF THE DRAWINGS

The above and other aspects, features, and benefits of various embodiments of the disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 is a diagram which shows a cylindrical battery cell in accordance with an embodiment of the present disclosure;

FIG. 2 is a diagram which shows a section view of the cylindrical battery cell in accordance with an embodiment of the present disclosure;

FIG. 3 is another diagram which shows the cylindrical battery cell in accordance with an embodiment of the present disclosure;

FIG. 4 is a diagram which shows some elements of a cap component in accordance with an embodiment of the present disclosure;

FIG. 5 is another diagram which shows some elements of a cap component in accordance with an embodiment of the present disclosure;

FIG. 6 is a diagram which shows the cap component in accordance with an embodiment of the present disclosure;

FIG. 7 is another diagram which shows the cap component in accordance with an embodiment of the present disclosure;

FIG. 8 is a diagram which shows a current collector in accordance with an embodiment of the present disclosure;

FIG. 9 is another diagram which shows a current collector in accordance with an embodiment of the present disclosure;

FIG. 10 is a diagram which shows a section view of the cylindrical battery cell in accordance with an embodiment of the present disclosure;

FIG. 11 is a diagram which shows a section view of the cylindrical battery cell in accordance with an embodiment of the present disclosure;

FIG. 12 is a diagram which shows a section view of the cylindrical battery cell in accordance with an embodiment of the present disclosure;

FIG. 13 is another diagram which shows the cylindrical battery cell in accordance with an embodiment of the present disclosure;

FIG. 14 is another diagram which shows a current collector in accordance with an embodiment of the present disclosure;

FIG. 15 is another diagram which shows the cylindrical battery cell in accordance with an embodiment of the present disclosure;

FIG. 16 is another diagram which shows the cylindrical battery cell in accordance with an embodiment of the present disclosure;

FIG. 17 is another diagram which shows a current collector in accordance with an embodiment of the present disclosure;

FIG. 18 is a diagram which shows a method for forming cylindrical battery cell in accordance with an embodiment of the present disclosure;

FIG. 19 is another diagram which shows a method for forming cylindrical battery cell in accordance with an embodiment of the present disclosure;

FIG. 20 is a diagram which shows the jellyroll structure and the current collector in accordance with an embodiment of the present disclosure;

FIG. 21 is a diagram which shows the jellyroll structure and the current collector in accordance with an embodiment of the present disclosure;

FIG. 22 is a diagram which shows the jellyroll structure and the cell housing in accordance with an embodiment of the present disclosure;

FIG. 23 is a diagram which shows a battery in accordance with an embodiment of the present disclosure.

### DETAILED DESCRIPTION

The present disclosure will now be described with reference to several example embodiments. It should be understood that these embodiments are discussed only for the purpose of enabling those skilled persons in the art to better understand and thus implement the present disclosure, rather than suggesting any limitations on the scope of the present disclosure.

It should be understood that when an element is referred to as being “connected” or “coupled” or “contacted” to another element, it may be directly connected or coupled or contacted to the other element or intervening elements may be present. In contrast, when an element is referred to as being “directly connected” or “directly coupled” or “directly contacted” to another element, there are no intervening elements present. Other words used to describe the relationship between elements should be interpreted in a like fashion (e.g., “between” versus “directly between”, “adjacent” versus “directly adjacent”, etc.).

As used herein, the terms “first” and “second” refer to different elements. The singular forms “a” and “an” are intended to include the plural forms as well, unless the context clearly indicates otherwise. The terms “comprises,” “comprising,” “has,” “having,” “includes” and/or “including” as used herein, specify the presence of stated features, elements, and/or components and the like, but do not preclude the presence or addition of one or more other features, elements, components and/or combinations thereof.

The term “based on” is to be read as “based at least in part on”. The term “cover” is to be read as “at least in part cover”. The term “one embodiment” and “an embodiment” are to be read as “at least one embodiment”. The term “another embodiment” is to be read as “at least one other embodiment”. Other definitions, explicit and implicit, may be included below.

In this disclosure, unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

### A First Aspect of Embodiments

A cylindrical battery cell is provided in the embodiments.

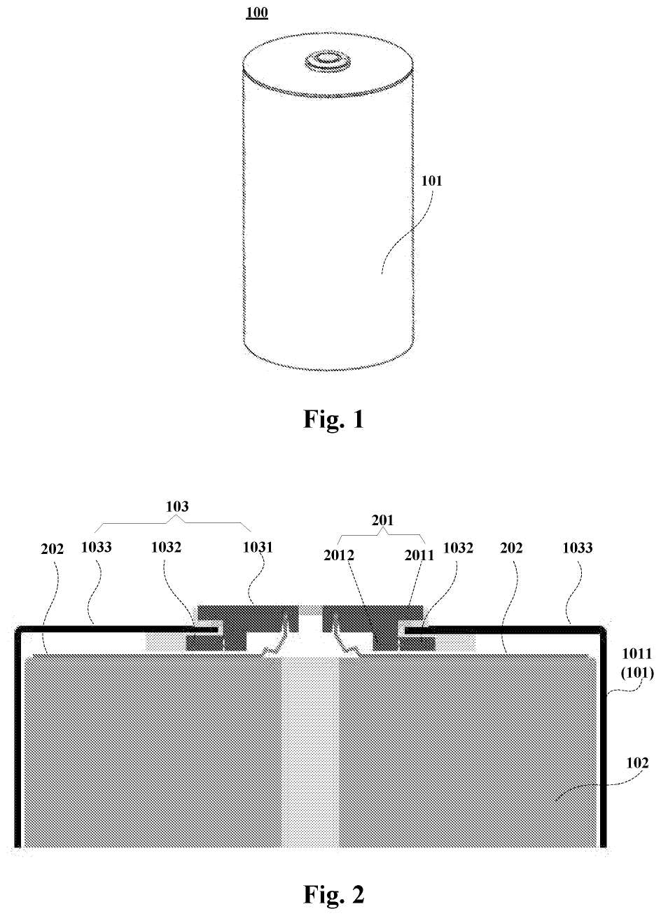

FIG. 1 is a diagram which shows a cylindrical battery cell 100 in accordance with an embodiment of the present disclosure. FIG. 2 is a diagram which shows a section view of the cylindrical battery cell 100 in accordance with an embodiment of the present disclosure.

As shown in FIG. 1 and FIG. 2, a cylindrical battery cell 100 at least includes: a cell housing 101, a jellyroll structure 102 and a cap component 103. The cell housing 101 at least has a cylindrical lateral portion 1011; the cap component 103 is arranged on the jellyroll structure 102 and is connected to the cylindrical lateral portion 1011 on a first side (an upper side) of the cell housing 101.

The jellyroll structure 102 is arranged inside the cell housing 101. For example, the jellyroll structure 102 includes a rolled anode foil, a rolled cathode foil and a rolled separator between the rolled anode foil and the rolled cathode foil. As for the detail of the jellyroll structure 102, please refer to relevant art.

As shown in FIG. 2, the cap component 103 at least includes a terminal 1031, a fixing element 1032 and a cap plate 1033, the cap plate 1033 includes an opening, the terminal 1031 includes a step-shape structure 201 and is arranged in the opening via the step-shape structure 201,

As shown in FIG. 2, the step-shape structure 201 includes a substrate portion 2011 and a rivet portion 2012, the substrate portion 2011 is blocked on a first side (such as an upper side or an upper surface) of the cap plate 1033, the rivet portion 2012 is extended from the substrate portion 2011 and through the opening, the fixing element 1032 is connected to (for example is welded with) an outer side (a lateral surface) of the rivet portion 2012 on a second side (such as a bottom side or a lower surface) of the cap plate 1033.

It should be appreciated that some components or elements are illustrated only as examples in FIG. 1 and FIG. 2. However, it is not limited thereto, for example, connections or positions of the components or elements may be adjusted, and/or, some components or elements may be omitted.

In this disclosure, a terminal having a step-shape structure is provided and the terminal is fixed with the cap plate by a fixing element. Therefore, an energy gravimetric and volumetric density of the battery cell is increased, and a cell inner resistance and an energy loss are decreased. Furthermore, a manufacturing process is simplified and costs consequently are reduced.

In some embodiments, as shown in FIG. 2, one or more flattened tabs of the jellyroll structure 102 on a first side (such as an upper side) of the jellyroll structure 102 is/are welded with a current collector 202. The current collector 202 is connected to the terminal 1031, for example, the current collector 202 and the terminal 1031 are weld by using a laser.

In some embodiments, as shown in FIG. 2, the cap plate 1033 and the cell housing 101 are integrally formed. However, it is not limited thereto, for example, the cap plate 1033 and the cell housing 101 may be two components, and the cap plate 1033 is supported by a crimped neck of the cell housing 101.

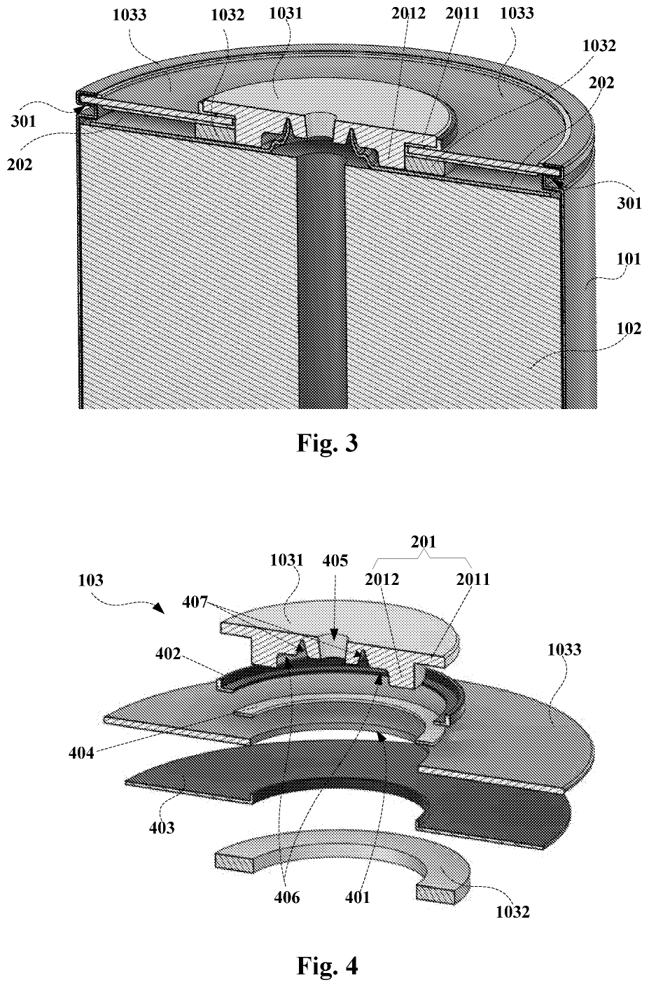

FIG. 3 is another diagram which shows the cylindrical battery cell 100 in accordance with an embodiment of the present disclosure; as shown in FIG. 3, the cap plate 1033 and the cell housing 101 are two components, and the cap plate 1033 is supported by a crimped neck 301 of the cell housing 101.

Next, some structures of the cap component will be illustrated as examples.

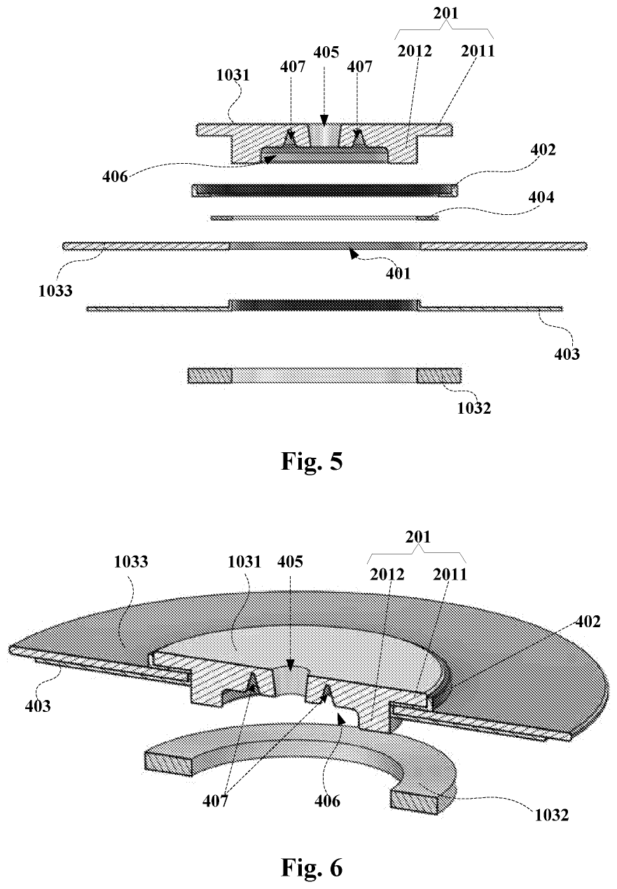

FIG. 4 is a diagram which shows some elements of a cap component in accordance with an embodiment of the present disclosure; FIG. 5 is another diagram which shows some elements of a cap component in accordance with an embodiment of the present disclosure.

As shown in FIGS. 4-5, the cap component 103 includes a terminal 1031, a fixing element 1032 and a cap plate 1033. The cap plate 1033 includes an opening 401. The terminal 1031 includes a step-shape structure 201. The step-shape structure 201 includes a substrate portion 2011 and a rivet portion 2012.

As shown in FIGS. 4-5, the cap component 103 further includes: a first holding element 402 which is to be arranged on the first side of the cap plate 1033. The cap component 103 further includes: a second holding element 403 which is to be arranged on the second side of the cap plate 1033. The cap component 103 further includes: a sealing element 404 which is to be arranged between the cap plate 1033 and the terminal 1031.

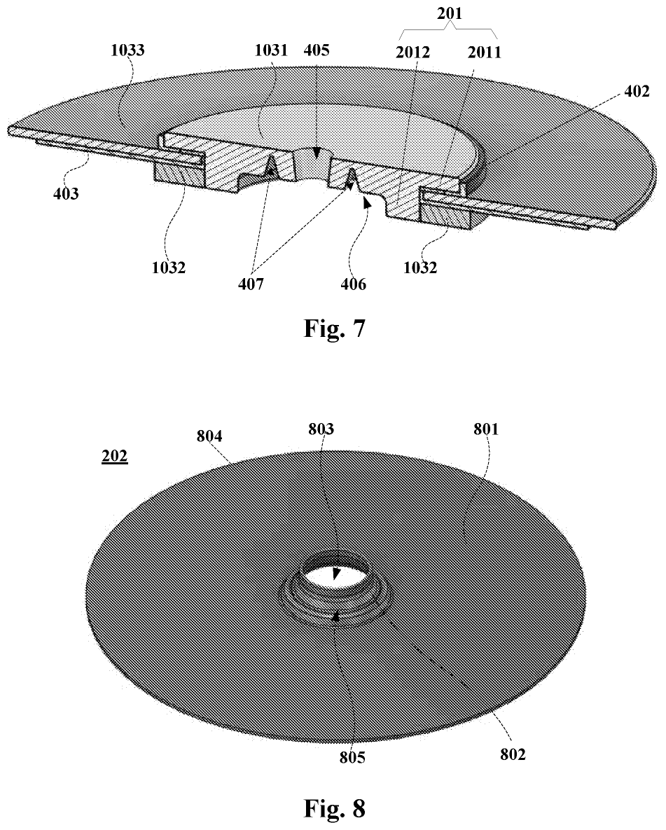

FIG. 6 is a diagram which shows the cap component in accordance with an embodiment of the present disclosure; FIG. 7 is another diagram which shows the cap component in accordance with an embodiment of the present disclosure.

As shown in FIGS. 6-7, the terminal 1031 is arranged in the opening 401 via the step-shape structure 201. The first holding element 402 and the second holding element 403 are used to isolate the terminal 1031 and the cap plate 1033.

As shown in FIGS. 6-7, the substrate portion 2011 is blocked on a first side (such as an upper side) of the cap plate 1033, the rivet portion 2012 is extended from the substrate portion 2011 and through the opening 401.

Furthermore, the fixing element 1032 is connected to an outer side of the rivet portion 2012 on a second side (such as a bottom side) of the cap plate 1033. For example, the fixing element 1032 and the rivet portion 2012 are weld by using a laser.

In some embodiments, as shown in FIG. 3 or 7, the rivet portion 2012 is weld with the fixing element 1032 (such as an aluminum ring), such that the terminal (an aluminum terminal) is fixed with the cap plate 1033 (such as a steel plate).

It should be appreciated that some components or elements are illustrated only as examples in FIG. 3-7. However, it is not limited thereto, for example, connections or positions of the components or elements may be adjusted, and/or, some components or elements may be omitted.

In some embodiments, as shown in FIGS. 4-7, an injection hole 405 is arranged in the terminal 1031, and the rivet portion 2012 is around the injection hole 405 in a circumference direction to form a decentralized structure. As shown in FIGS. 4-7, a space 406 is formed by the rivet portion 2012 on a second side of the terminal 1031.

Therefore, the rivet portion 2012 is not a pin structure in the center of the terminal, but an extended ring around the outer diameter of the terminal. This further enables to use the space in the middle of terminal. Furthermore, the structure has better mechanical stability compared to conventional design.

In some embodiments, a first groove portion is arranged on a second side (a lower surface or a bottom side) of the terminal within the space and around the injection hole in the circumference direction.

For example, as shown in FIGS. 4-7, a first groove portion 407 is arranged on a second side (such as a bottom side) of the terminal 1031 within the space 406, and the first groove portion 407 is around the injection hole 405 in the circumference direction.

In some embodiments, the current collector includes a flat plate and a raised portion, the raised portion being extended from the flat plate and having an opening. For example, the raised portion comprises at least one bended portion to form a tolerance structure.

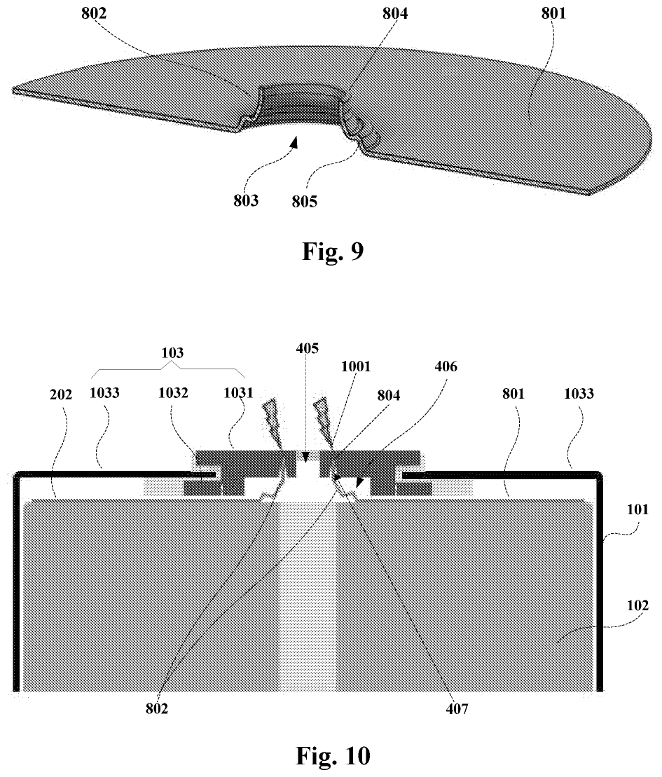

FIG. 8 is a diagram which shows a current collector in accordance with an embodiment of the present disclosure; FIG. 9 is another diagram which shows a current collector in accordance with an embodiment of the present disclosure.

As shown in FIGS. 8-9, the current collector 202 includes a flat plate 801 and a raised portion 802, the raised portion 802 is extended from the flat plate 801. As shown in FIGS. 8-9, the raised portion 802 has an opening 803 and an ending part 804. Furthermore, the raised portion 802 includes at least one bended portion 805.

In some embodiments, the raised portion is arranged within the space formed by the rivet portion on a second side of the terminal when the terminal and the jellyroll structure are assembled.

Therefore, a tolerance structure is provided and manufacturability is ensured by considering a flexible area (multiple bended) in the current collector, such that a tolerance-forgiving design is provided and a manufacturing process is simplified.

In some embodiments, an ending part of the raised portion is inserted into the first groove portion which is arranged on the second side of the terminal. The terminal and the current collector are weld by a laser at a first position corresponding to the ending part of the raised portion from outside of the cell housing.

FIG. 10 is a diagram which shows a section view of the cylindrical battery cell 100 in accordance with an embodiment of the present disclosure. As shown in FIG. 10, an ending part 804 of the raised portion 802 is inserted into the first groove portion 407 which is arranged on the second side of the terminal 1031. The terminal 1031 and the current collector 202 are weld by a laser at a first position 1001 corresponding to the ending part 804 of the raised portion 802 from outside of the cell housing 101.

In some embodiments, a space is formed by the rivet portion on a second side of the terminal; and a second groove portion is arranged on a second side of the terminal within the space and connected to the injection hole.

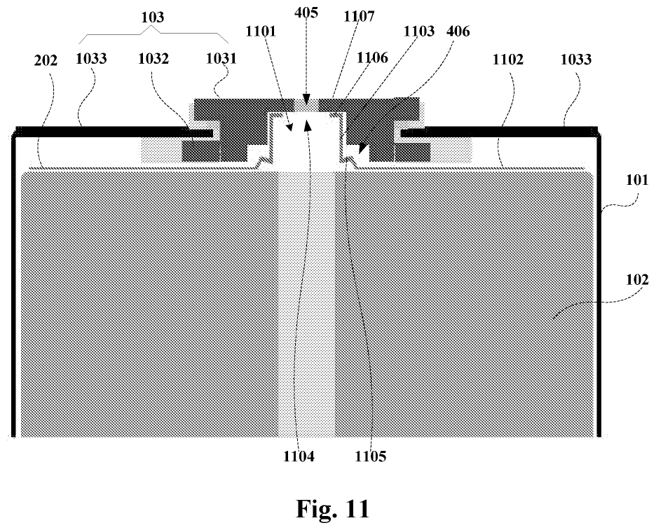

FIG. 11 is a diagram which shows a section view of the cylindrical battery cell 100 in accordance with an embodiment of the present disclosure. As shown in FIG. 11, the space 406 is formed by the rivet portion 2012 on a second side of the terminal 1031; and a second groove portion 1101 is arranged on a second side of the terminal 1031 within the space 406. As shown in FIG. 11, the second groove portion 1101 is connected to the injection hole 405.

In some embodiments, as shown in FIG. 11, the current collector 202 includes a flat plate 1102 and a raised portion 1103, the raised portion 1103 is extended from the flat plate 1102. As shown in FIG. 11, the raised portion 1103 has an opening 1104. Furthermore, the raised portion 1103 includes at least one bended portion 1105.

As shown in FIG. 11, an ending part 1106 (having a flat portion) of the raised portion 1103 is arranged at a position in the second groove portion 1101, the position is between an injection hole 405 and the rivet portion 1012 in a radial direction.

In some embodiments, the terminal 1031 and the current collector 202 are weld by a laser at a second position 1107 corresponding to the ending part 1106 of the raised portion 1103 from outside of the cell housing.

In some embodiments, a space is formed by the rivet portion on a second side of the terminal; and a third groove portion is arranged on a first side of the terminal and around the injection hole in the circumference direction.

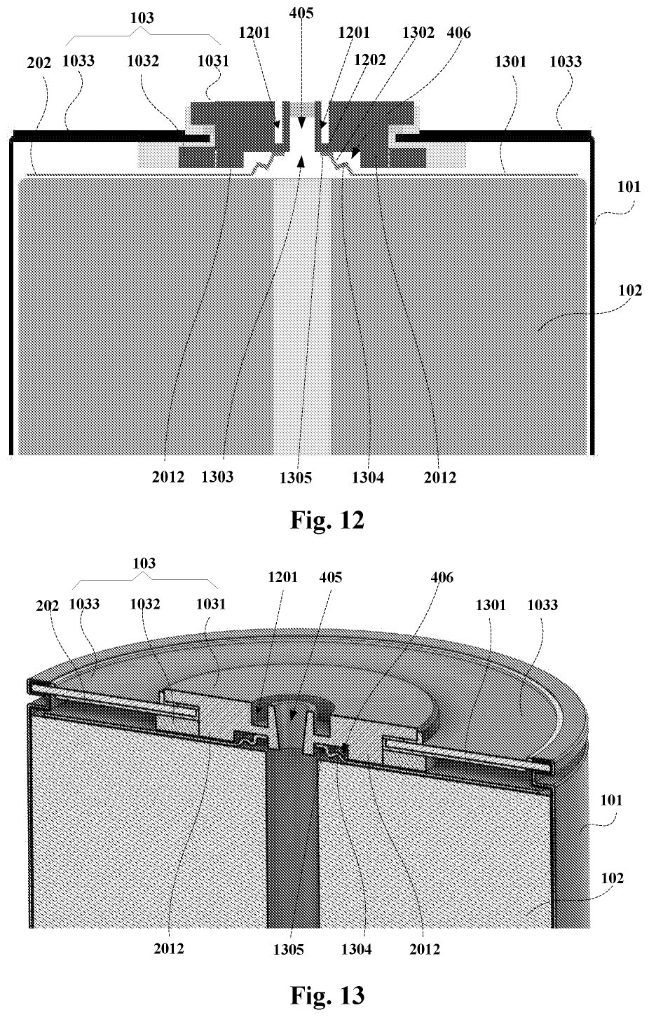

FIG. 12 is another diagram which shows the cylindrical battery cell 100 in accordance with an embodiment of the present disclosure; FIG. 13 is another diagram which shows the cylindrical battery cell 100 in accordance with an embodiment of the present disclosure.

As shown in FIGS. 12-13, the space 406 is formed by the rivet portion 2012 on a second side of the terminal 1031; and a third groove portion 1201 is arranged on a first side of the terminal 1031, and the third groove portion 1201 is around the injection hole 405 in the circumference direction.

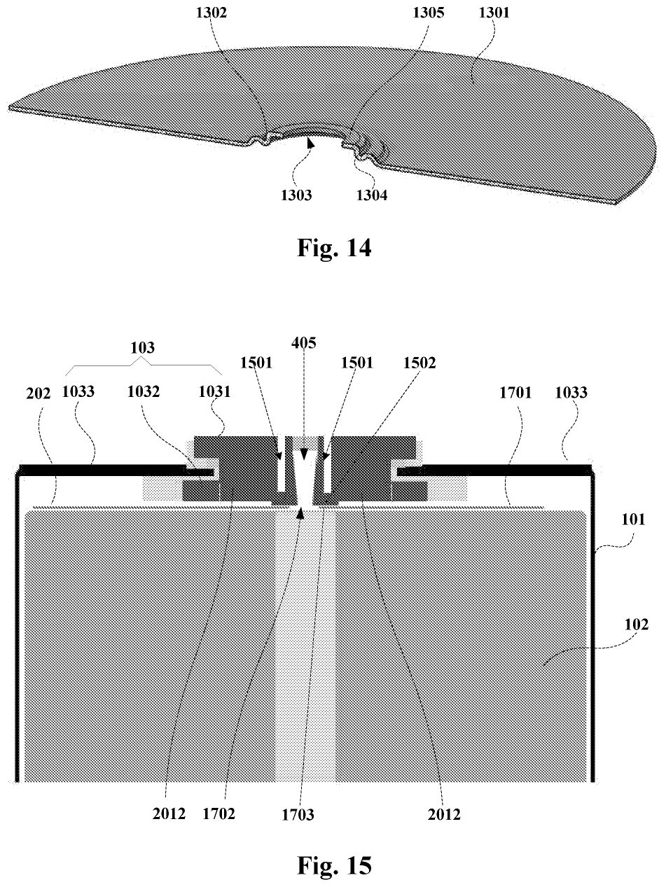

FIG. 14 is another diagram which shows a current collector in accordance with an embodiment of the present disclosure. As shown in FIG. 14, the current collector 202 includes a flat plate 1301 and a raised portion 1302, the raised portion 1302 is extended from the flat plate 1301. As shown in FIG. 13, the raised portion 1302 has an opening 1303. Furthermore, the raised portion 1302 includes at least one bended portion 1304.

In some embodiments, an ending part 1305 (having a flat portion) of the raised portion 1302 is arranged at a third position 1202 on a second side of the terminal, the third position 1202 is corresponding to the third groove portion 1201 arranged on a first side of the terminal 1031.

In some embodiments, the terminal 1031 and the current collector 202 are weld by a laser at the third groove portion 1201 (used as a laser welding cavity) from outside of the cell housing 101. The third groove portion 1201 may be continuous in the whole circumference, and it is not limited thereto, for example, a plurality of segments may be arranged as the third groove portion 1201.

In some embodiments, a fourth groove portion is arranged on a first side of the terminal and around the injection hole in the circumference direction.

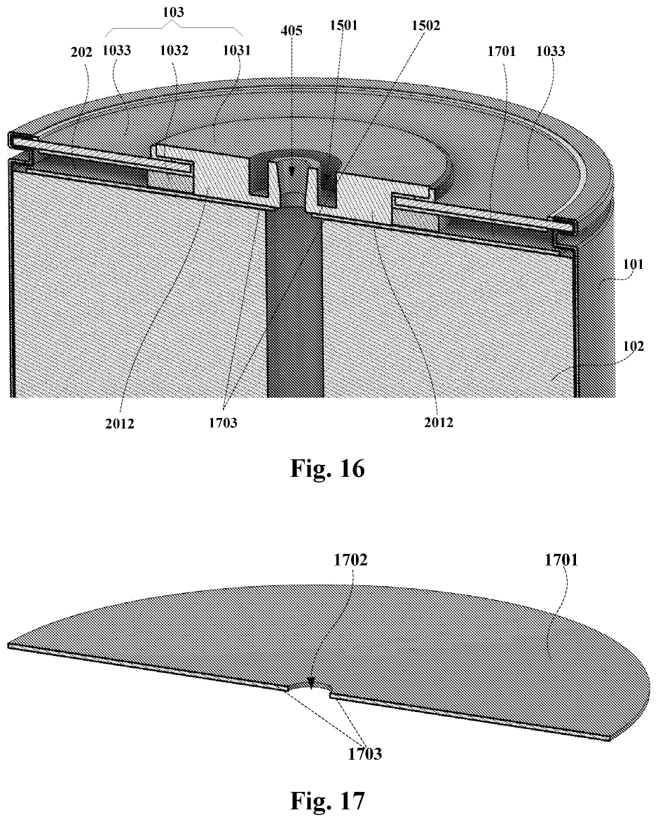

FIG. 15 is another diagram which shows the cylindrical battery cell 100 in accordance with an embodiment of the present disclosure; FIG. 16 is another diagram which shows the cylindrical battery cell 100 in accordance with an embodiment of the present disclosure.

As shown in FIGS. 15-16, a fourth groove portion 1501 is arranged on a first side of the terminal 1031, and the fourth groove portion 1501 is around the injection hole 405 in the circumference direction.

FIG. 17 is another diagram which shows a current collector in accordance with an embodiment of the present disclosure. As shown in FIG. 17, the current collector 202 includes a flat plate 1701, the flat plate 1701 has an opening 1702.

In some embodiments, as shown in FIGS. 15-16, an ending part 1703 of the flat plate 1701 is arranged at a fourth position 1502 on a second side of the terminal 1031, the fourth position 1502 is corresponding to the fourth groove portion 1501 arranged on a first side of the terminal.

In some embodiments, the terminal 1031 and the current collector 202 are weld by a laser at the fourth groove portion 1501 (used as a laser welding cavity) from outside of the cell housing 101. The fourth groove portion 1501 may be continuous in the whole circumference, and it is not limited thereto, for example, a plurality of segments may be arranged as the fourth groove portion 1501.

In some embodiments, the cap component 103 is formed by using a plastic injection mold. Therefore, a manufacturing process is simplified and costs consequently is reduced, and it is not limited thereto, the cap component 103 may be formed by other processes.

In this disclosure, a laser is used to weld some components in a welding process, but it is not limited thereto. For example, other ways such as an ultrasonic may be used in the welding process.

In some embodiments, the cell housing 101 is made up of steel, it is not limited thereto. The current collector 202 is mainly made up of aluminum, and the terminal 1031 is mainly made up of aluminum, it is not limited thereto. Furthermore, the terminal 1031 is cathode terminal (positive terminal), and it is not limited thereto.

In some embodiments, the current collector 202 is pre-shaped and an injection hole is created on the current collector 202, the injection hole being through the current collector 202 and the terminal 1031 after the terminal 1031 is welded with the current collector 202.

In this disclosure, a decentralized rivet structure creates a space in the middle of the terminal (inner side) to integrate the current collector, which can be laser welded from outside of the terminal. This reduces a total current path from the jellyroll structure to the terminal, and subsequently reduces the cell inner resistance.

Furthermore, a capability of welding the current collector to the terminal from outside of the cell housing simplifies significantly a manufacturing process or an assembly process. In addition, quality issues are decreased due to particle generation inside of the cell housing.

The design enables a relatively compacter structure (specially in Z-Axis) which improves a volumetric filling ratio or an energy density of the battery cell. Furthermore, the technique solution of this disclosure can maximize a space usage of the cell (higher volumetric filling ratio, higher energy content per cell, lower cost per cell mechanic).

Furthermore, a plastic injection mold component in combination with the jellyroll structure enables laser welding of positive terminal from outside of the cell housing. Therefore, the technical solution simplifies significantly the cell structure, reduces number of parts, enables a lean production process (higher quality and lower scrap rate), which in turn reduces cell manufacturing costs considerably.

It is to be understood that, the above examples or embodiments are discussed for illustration, rather than limitation. Those skilled in the art would appreciate that there may be many other embodiments or examples within the scope of the present disclosure.

It can be seen from the above embodiments, a cap component at least includes a terminal, a fixing element and a cap plate, the terminal including a step-shape structure, wherein the step-shape structure includes a substrate portion and a rivet portion, the substrate portion being blocked on a first side of the cap plate, the rivet portion being extended from the substrate portion, the fixing element being connected to an outer side of the rivet portion on a second side of the cap plate.

Therefore, an energy gravimetric and volumetric density of the battery cell are increased, and a cell inner resistance and an energy loss are decreased. Furthermore, a manufacturing process is simplified and costs consequently are reduced.

### A Second Aspect of Embodiments

A method for forming cylindrical battery cell is provided in the embodiments. The corresponding devices are illustrated in the first aspect of embodiments, and the same contents as those in the first aspect of embodiments are omitted.

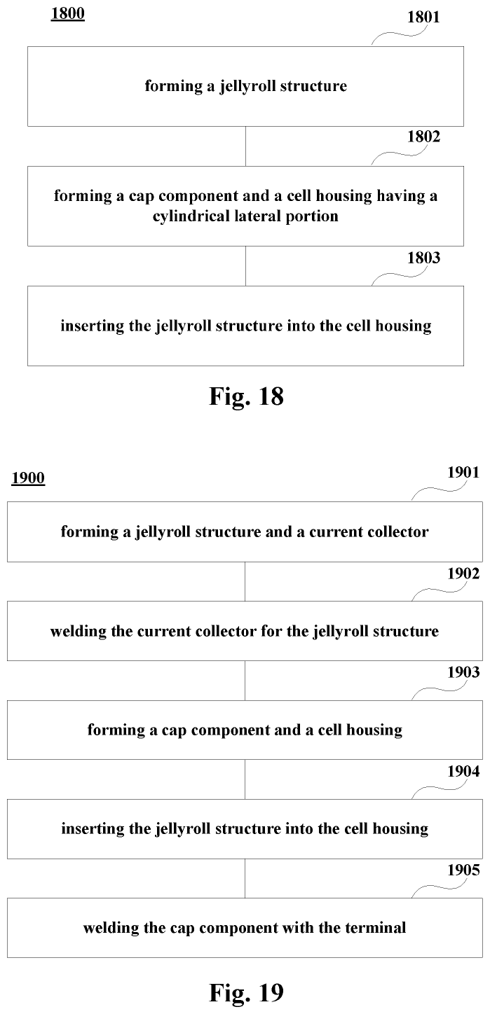

FIG. 18 is a diagram which shows a method for forming cylindrical battery cell in accordance with an embodiment of the present disclosure. As shown in FIG. 18, a method 1800 for forming cylindrical battery cell includes:
1801, forming a jellyroll structure;
1802, forming a cap component and a cell housing having a cylindrical lateral portion;
1803, inserting the jellyroll structure into the cell housing.

In this disclosure, the cap component at least comprises a terminal, a fixing element and a cap plate, the cap plate having an opening, the terminal comprising a step-shape structure and being arranged in the opening via the step-shape structure,
wherein the step-shape structure comprises a substrate portion and a rivet portion, the substrate portion being blocked on a first side of the cap plate, the rivet portion being extended from the substrate portion and through the opening, the fixing element being connected to an outer side of the rivet portion on a second side of the cap plate.

It should be appreciated that FIG. 18 is only an example of the disclosure, but it is not limited thereto. For example, the order of operations at blocks or steps may be adjusted, and/or, some blocks or steps may be omitted. Moreover, some blocks or steps not shown in FIG. 18 may be added.

FIG. 19 is another diagram which shows a method for forming cylindrical battery cell in accordance with an embodiment of the present disclosure. As shown in FIG. 19, a method 1900 for forming cylindrical battery cell includes:
1901, forming a jellyroll structure and a current collector;

For example, the jellyroll structure and the current collector are separately formed by respective processes. The details of the processes are omitted in this disclosure, and please refer to relevant art. Next, the current collectors and the terminals in the FIGS. 2-10 are used as examples to illustrate the method, and it is not limited thereto, the current collectors and the terminals illustrated in the FIGS. 11-17 may be used.

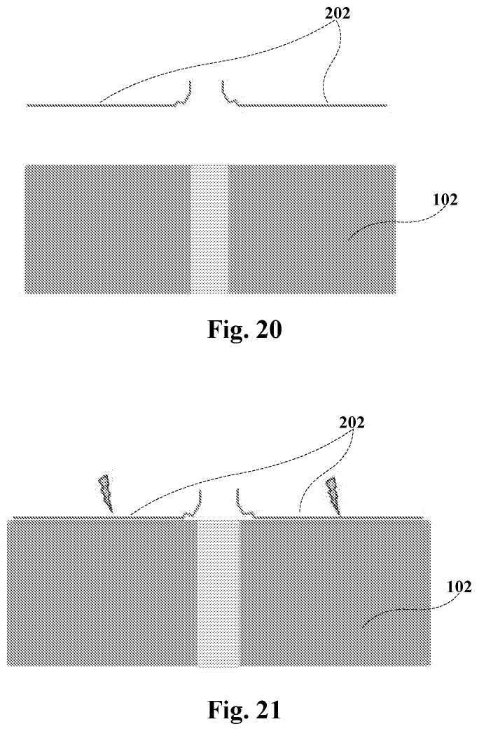

FIG. 20 is a diagram which shows a jellyroll structure and a current collector in accordance with an embodiment of the present disclosure. As shown in FIG. 20, there are some flattened aluminum tabs on the upper side of the jellyroll structure 102 after a tab-flattening process, and there is a current collector 202.

As shown in FIG. 19, the method 1900 for forming cylindrical battery cell includes:
1902, welding the current collector for the jellyroll structure.

FIG. 21 is a diagram which shows the jellyroll structure and a current collector in accordance with an embodiment of the present disclosure. As shown in FIG. 21, the current collector 202 and the flattened aluminum tabs are pre-welded on the upper side of the jellyroll structure 102.

As shown in FIG. 19, the method 1900 for forming cylindrical battery cell includes:
1903, forming a cap component and a cell housing.

For example, the cap component 103 is formed by using a plastic injection mold, the structure of the cap component 103 is shown in FIGS. 4-7. The cap plate 1033 and the cell housing 101 are integrally formed. However, it is not limited thereto, for example, the cap plate 1033 and the cell housing 101 may be two components, and the cap plate 1033 is supported by a crimped neck of the cell housing 101.

As shown in FIG. 19, the method 1900 for forming cylindrical battery cell includes:
1904, inserting the jellyroll structure into the cell housing.

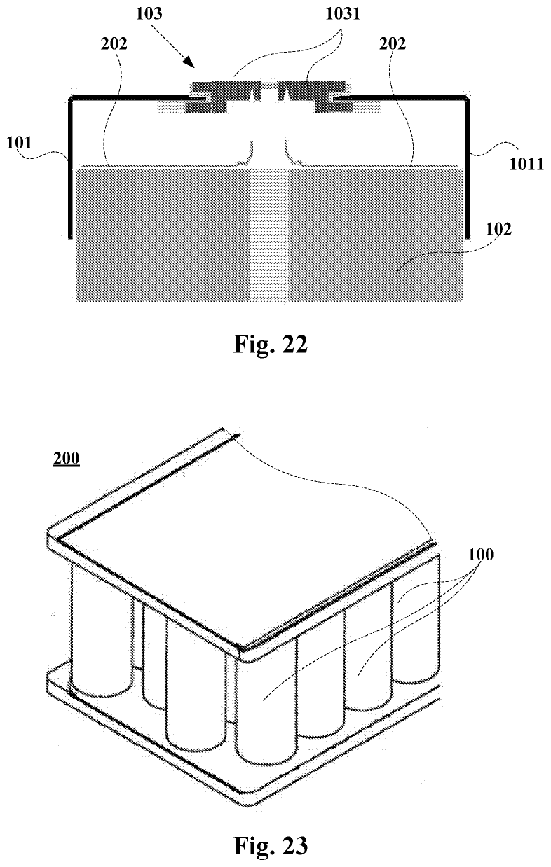

FIG. 22 is a diagram which shows the jellyroll structure and the cell housing in accordance with an embodiment of the present disclosure. As shown in FIG. 22, the jellyroll structure 102 is going to be inserted into the cell housing 101.

As shown in FIG. 19, the method 1900 for forming cylindrical battery cell includes:
1905, welding the cap component with the terminal.

For example, as shown in FIG. 10, the terminal 1031 is welded with the current collector 202 by using a laser from outside of the cell housing 101.

It should be appreciated that FIG. 19 is only an example of the disclosure, but it is not limited thereto. For example, the order of operations at blocks or steps may be adjusted, and/or, some blocks or steps may be omitted. Moreover, some blocks or steps not shown in FIG. 19 may be added.

Furthermore, some components or elements are illustrated only as examples in FIG. 20 to FIG. 22. However, it is not limited thereto, for example, connections or positions of the components or elements may be adjusted, and/or, some components or elements may be omitted.

It can be seen from the above embodiments, a cap component at least includes a terminal, a fixing element and a cap plate, the terminal including a step-shape structure, wherein the step-shape structure includes a substrate portion and a rivet portion, the substrate portion being blocked on a first side of the cap plate, the rivet portion being extended from the substrate portion, the fixing element being connected to an outer side of the rivet portion on a second side of the cap plate.

Therefore, an energy gravimetric and volumetric density of the battery cell are increased, and a cell inner resistance and an energy loss are decreased. Furthermore, a manufacturing process is simplified and costs consequently are reduced.

### A Third Aspect of Embodiments

A battery is provided in the embodiments. The corresponding devices and the method are illustrated in the first and second aspects of embodiments, and the same contents as those in the first and second aspects of embodiments are omitted.

In some embodiments, the battery includes a plurality of the cylindrical battery cell. The cylindrical battery cell is illustrated according to the first aspects of embodiments.

FIG. 23 is a diagram which shows a battery 200 in accordance with an embodiment of the present disclosure. As shown in FIG. 23, the battery 200 may include a plurality of the cylindrical battery cell 100.

It should be appreciated that FIG. 23 is only an example of the disclosure, but it is not limited thereto. For example, some components or elements are illustrated only as examples in FIG. 23. However, it is not limited thereto, for example, connections or positions of the components or elements may be adjusted, and/or, some components or elements may be omitted.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and integrated circuits (ICs) with minimal experimentation.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device.

While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous.

Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A cylindrical battery cell, at least comprising:
a cell housing having a cylindrical lateral portion;
a jellyroll structure which is arranged inside the cell housing; and
a cap component which is arranged on the jellyroll structure and is connected to the cylindrical lateral portion on a first side of the cell housing;
wherein the cap component at least comprises a terminal, a fixing element and a cap plate, the cap plate having an opening, the terminal comprising a step-shape structure and being arranged in the opening via the step-shape structure,
wherein the step-shape structure comprises a substrate portion and a rivet portion, the substrate portion being blocked on a first side of the cap plate, the rivet portion being extended from the substrate portion and through the opening, the fixing element being connected to an outer side of the rivet portion on a second side of the cap plate.

2. The cylindrical battery cell according to claim 1, wherein an injection hole is arranged in the terminal, and the rivet portion is around the injection hole in a circumference direction to form a decentralized structure.

3. The cylindrical battery cell according to claim 2, wherein a space is formed by the rivet portion on a second side of the terminal; and a first groove portion is arranged on the second side of the terminal within the space and around the injection hole in the circumference direction; or,
wherein a space is formed by the rivet portion on a second side of the terminal; and a second groove portion is arranged on the second side of the terminal within the space and connected to the injection hole; or,
wherein a space is formed by the rivet portion on a second side of the terminal; and a third groove portion is arranged on a first side of the terminal and around the injection hole in the circumference direction; or,
wherein a fourth groove portion is arranged on a first side of the terminal and around the injection hole in the circumference direction.

4. (canceled)

5. (canceled)

6. (canceled)

7. The cylindrical battery cell according to claim 1, wherein one or more flattened tabs of the jellyroll structure on a first side of the jellyroll structure is/are welded with a current collector, the current collector being connected to the terminal.

8. The cylindrical battery cell according to claim 7, wherein the current collector comprises a flat plate and a raised portion, the raised portion being extended from the flat plate and having an opening.

9. The cylindrical battery cell according to claim 8, wherein the raised portion comprises at least one bended portion to form a tolerance structure.

10. The cylindrical battery cell according to claim 9, wherein the raised portion is arranged within a space formed by the rivet portion on a second side of the terminal when the terminal and the jellyroll structure are assembled.

11. The cylindrical battery cell according to claim 10, wherein an ending part of the raised portion is inserted into a first groove portion which is arranged on the second side of the terminal.

12. The cylindrical battery cell according to claim 11, wherein the terminal and the current collector are weld by a laser at a first position corresponding to the ending part of the raised portion from outside of the cell housing.

13. The cylindrical battery cell according to claim 10, wherein an ending part of the raised portion is arranged in a second groove portion between an injection hole and the rivet portion in a radial direction.

14. The cylindrical battery cell according to claim 13, wherein the terminal and the current collector are weld by a laser at a second position corresponding to the ending part of the raised portion from outside of the cell housing.

15. The cylindrical battery cell according to claim 10, wherein an ending part of the raised portion is arranged at a third position on the second side of the terminal, the third position being corresponding to a third groove portion arranged on a first side of the terminal.

16. The cylindrical battery cell according to claim 15, wherein the terminal and the current collector are weld by a laser at the third groove portion from outside of the cell housing.

17. The cylindrical battery cell according to claim 7, wherein the current collector comprises a flat plate, the flat plate having an opening.

18. The cylindrical battery cell according to claim 17, wherein an ending part of the plat plate is arranged at a fourth position on a second side of the terminal, the fourth position being corresponding to a fourth groove portion arranged on a first side of the terminal.

19. The cylindrical battery cell according to claim 18, wherein the terminal and the current collector are weld by a laser at the fourth groove portion from outside of the cell housing.

20. The cylindrical battery cell according to claim 1, wherein the cap component further comprises:
a first holding element which is arranged on the first side of the cap plate and is used to isolate the terminal and the cap plate; and
a second holding element which is arranged on the second side of the cap plate and is used to isolate the terminal and the cap plate.

21. The cylindrical battery cell according to claim 1, wherein the cap component further comprises:
a sealing element which is arranged between the cap plate and the terminal; or,
wherein the cap plate is supported by a crimped neck of the cell housing; or,
wherein the cap plate and the cell housing are integrally formed.

22. (canceled)

23. (canceled)

24. A method for forming cylindrical battery cell, comprising:
forming a jellyroll structure;
forming a cap component and a cell housing having a cylindrical lateral portion; and
inserting the jellyroll structure into the cell housing;
wherein the cap component at least comprises a terminal, a fixing element and a cap plate, the cap plate having an opening, the terminal comprising a step-shape structure and being arranged in the opening via the step-shape structure,
wherein the step-shape structure comprises a substrate portion and a rivet portion, the substrate portion being blocked on a first side of the cap plate, the rivet portion being extended from the substrate portion and through the opening, the fixing element being connected to an outer side of the rivet portion on a second side of the cap plate.

25. A battery, comprising a plurality of cylindrical battery cells according to claim 1.
